(19) United States
(12) Patent Application Publication
(10) Pub. No.: US 2007/0148401 A1
(43) Pub. Date: Jun. 28, 2007

(54) Protective coverings

(76) Inventors: David McGlade, Stockton On Tees (GB); Alan Harrison, Stockton On Tees (GB)

Correspondence Address: WILLIAM COLLARD;COLLARD & ROE, P.C., 1077 NORTHERN BOULEVARD, ROSLYN, NY, 11576, US

(21) Appl. No.: 11/320,082

(22) Filed: Dec. 28, 2005

(51) Int. Cl. B32B 3/06

(52) U.S. Cl. 428/99

(57) ABSTRACT

A protective cover for preventing damage from vehicle tires. The cover can comprise a strip of material adapted to be wrapped around a running surface of a tire, and to cover at least part of the tire side walls. In this case, the ends of the strip can be adapted to overlap and have complementary securing means capable of being secured on any relative position within a range defined by the lengthwise extent of the securing means on at least one end.

### FIELD OF THE INVENTION

This invention relates to protective coverings in particular to protective coverings for vehicle tyres to protect surfaces from damage by the vehicle tyres. Surfaces such as smooth concrete or other floors can be scuffed, damaged or soiled when vehicles such as lifting or carrying trucks are driven over them. This necessitates cleaning and making good of the surface following the task concerned.

### DESCRIPTION OF THE PRIOR ART

In the 1920's and 1930's it was customary to carry a spare tyre, or spare wheel on one side of the trunk of a vehicle. Because exposure to air and strong sunlight causes the rubber to deteriorate overtime, a number of proposals were made for covers for spare wheels or spare tyres to protect the material of the tyres. Examples of such covers are described in U.S. Pat. Nos. 3,326,259; 2,070,819; 1,967,522; 1,755,133; 1,700,081; and 1,303,224.

More recently however, the need to protect surfaces against scuffing, marking, and other damage caused by tyres of vehicles running upon the surfaces, has been recognised, and in U.S. Pat. No. 5,439,727 it is proposed to provide a protective cover, intended to serve as an anti-scuff device for protecting surfaces from the tyre. In this patent, a cover for a tyre comprises a strip of material having a high degree of abrasion resistance and a high degree of scuff resistance. The cover is secured by draw strings around the lengthwise edges of the strip, which in use lie alongside the side walls of the tyre, and the ends of the cover are abutted, and folded over and stitched together, or alternatively the end join is covered by a stretchable piece of material.

The great disadvantage of this is, that for each diameter of tyre, it is necessary to provide a specifically tailored cover, having a length approximately equal to the circumference of the tyre, for each standard size of tyre in general use. Further, the use of side draw cords, which are pulled taut and tied up at the join, involves a time consuming operation in equipping a vehicle such as a lift truck to work in an environment where protection is required.

### SUMMARY OF THE INVENTION

An object of the invention is therefore to provide a protective tyre cover which can be adapted to gross differences in tyre circumference, and which can also be quickly and easily placed on and removed from vehicle tyres.

According to the invention a protective cover for preventing damage by vehicle tyres, comprises a strip of material adapted to be wrapped about the running surface of a tyre, and to cover at least part of the tyre side walls, the ends of the strip being adapted to overlap, and being provided with complementary securing means capable of being secured in any relative position within a range defined by the lengthwise extent of said securing means on at least one said end.

Preferably the lengthwise extent of said securing means on at least one said end is a significant proportion of the length of the cover, and the lengthwise extent of said securing means on at least one said end may be from 20 to 30% of the length of the cover.

Said complementary securing means may be provided on one said end of the strip on a first surface thereof which is adapted to face outwardly of a tyre in position of use, and disposed as one or more lengthwise strips on said first surface.

Advantageously said lengthwise strips are disposed one adjacent to and parallel to each respective longer side of the strip, extending from said end.

The complementary securing means may further comprise, disposed on the other said end of the strip on a second opposite surface thereof, one or more strips of material complementary to be engageable with the strip or strips provided on said one end of the strip.

The complementary strip or strips preferably include or comprise a strip extending adjacent and parallel to said other end of the strip on said second opposite surface, so as to be engageable with the lengthwise strips on said other end on overlapping said ends after wrapping the cover about a tyre.

The complementary securing means may comprise hook-and-pile complementary fasteners of the VELCRO tyre, and the longitudinal edges of the strip are preferably each formed with a tunnel seam, each said seam having an elastic cord extending there through and being anchored at each end of the cover strip.

A preferred embodiment of protective cover for a vehicle tyre will now be described by way of example with reference to the accompanying drawings.

### DESCRIPTION OF THE DRAWINGS

FIG. 1 is a perspective view of a protective tyre cover according to the invention out of use, showing the face of the cover which will be presented outwardly with respect to a wheel when in use upon a tyre;

FIG. 2 is a similar view of the protective tyre cover according to FIG. 1, showing the opposite face when out of use, that is the face which will be presented inwardly towards the wheel when in use upon a tyre;

FIG. 3 shows the overlapped ends of the tyre cover; and

FIG. 4 shows the protective cover in use on a tyre and wheel of a vehicle.

### DESCRIPTION OF PREFERRED EMBODIMENT

A protective cover 10 for a tyre is shown which comprises an elongate rectangular strip of cloth, having suitable wear and scuff resistance properties.

The cover 10 can be assembled in place on a tyre 11 of a wheel 12 of a vehicle (not shown) for the purpose of protecting the floors particularly of interior areas in the latter stages of construction, also in warehousing and the use of mobile cleaning machinery for example. The vehicles to the wheels of which such protective covers 10 may be applied include fork lifts, trucks, and sweeping and cleaning machinery. The floors requiring protection may include plain concrete, including outdoor areas, timber or parquetry floors.

The protective covers may also be provided for delivery vehicles and serve to prevent or minimise scuffing, rubber markings, or the introduction of outside dirt.

More particularly, the elongated rectangular strip which forms the cover 10 comprises opposite elongate edges 14, 15 and opposite ends 16, 17. The edges 14 and 15 are each formed with a tunnel seam 18 within each of which extends on elastic or resilient yarn 19 (shown by a broken line) which is tacked or otherwise anchored at each end 16 and 17 of the respective seam 18. This ensures that the edges 14, 15 contract to fit the reduced circumference of the inner edges of the cover when in position on the tyre, as shown in FIG. 4, without recourse to draw cords which entail time-consuming fastening operations.

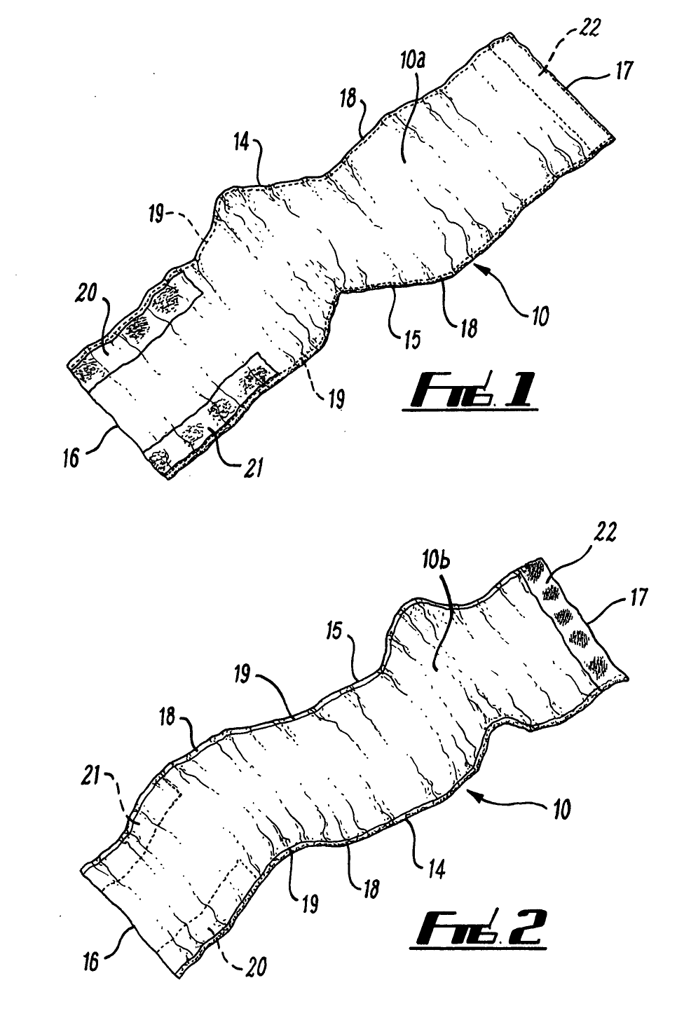

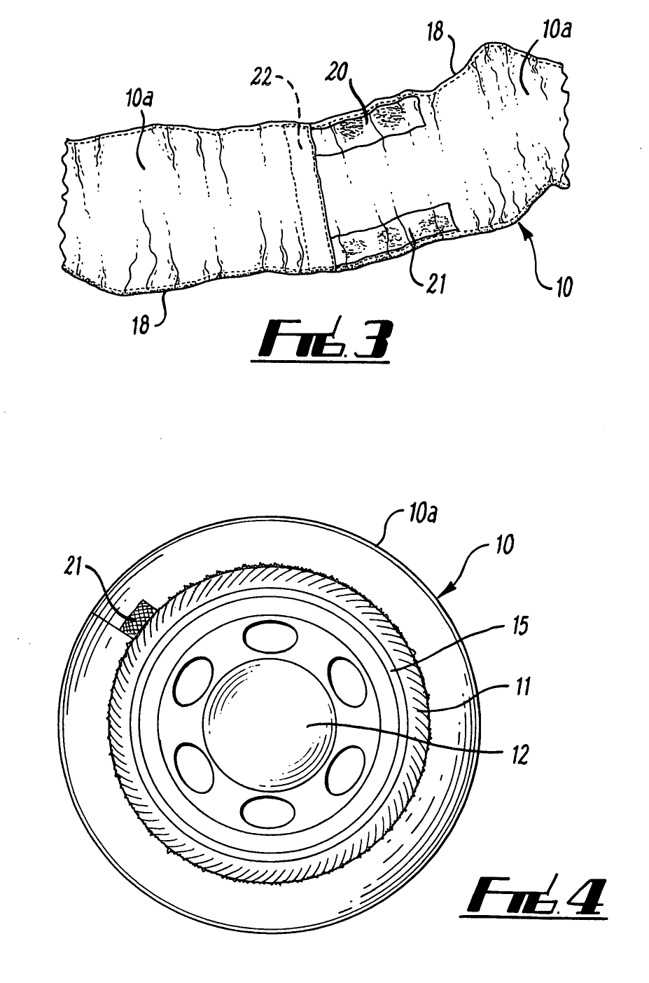

FIG. 1 shows a face or side 10a of the strip 10 which is, in position of use, presented to face outwardly of the tyre or wheel, whilst FIG. 2 shows the opposed face or side 10b of strip 10 which is, in position of use presented to face inwardly of the tyre or wheel.

The face 10a of the strip 10 is provided, towards end 16, with VELCRO or the like strips 20, 21 extending one alongside each side edge 14, 15 and parallel to the edges, offset inwards to leave the seam region 18 uncovered. The VELCRO strips 20, 21 extend for several inches, and may extend for 20-30% of the length of the strip 10.

The opposed face 10b of the strip 10 is provided adjacent end 17 with a complementary strip 22 of VELCRO material adapted to adhere to the strips 20, 21.

In use, the strip 10 is placed around the circumference of a tyre 11, with face 10a facing outwardly and face 10b facing inwardly. The ends 16, 17 of the strip 10 are joined after suitable tensioning, by overlapping the end 17 over the end 16 and the VELCRO strip 22 adhered to the strips 20, 21. The length of the strips 20, 21 makes possible both adjustment of the cover 10 for desired tension, and also enables a single size of cover to be used for a range of different tyre, and thus wheel, diameters.

For example, a cover strip 10 of 50 inches length and with elongate VELCRO strips 20, 21 say 16 inches in length, can be used with tyres having diameters in the range 12 to 15 inches, which are typical for vehicles used in warehousing vehicles for example.

Within the scope of the invention however, it is possible that complementary strips of e.g. VELCRO may be differently disposed in the respective ends 16 and 17 of the cover strip 10. For example the strips on end 6 of the upper surface 10a may be disposed as an array of strips parallel to the end 16, or be disposed in a herring bone or ‘V’ echelon pattern. More than one strip may be provided at end 17.

Complementary securing means other than VELCRO may be used, but hook and pile fabric fasteners of the VELCRO type are preferred, but contact peelable adhesives for example may be used.

As seen in FIG. 4, the cover 10 not only covers the running surface of the tyre 11, but extends partly over the side walls of the tyre 11. The cover 10 is tensioned by the elastic cords 19 to contract the edges 14, 15 to the reduced circumference of the edges as compared to the running surface without use of draw cords which have to be manually tightened and secured, and the VELCRO or other complementary fasteners are quick and easy to use, so that the covers 10 may be quickly applied to a vehicle on or before entry to a zone where protection is required.

The tyre covers 10 may be laid out on the floor in front of the wheels to which they are to be applied, then the vehicle driven over the covers so that the wheels stand on the covers. The ends of the covers 10 are then pulled around the wheel tyres and overlapped and secured in a quick and easy operation.

We claim:

1. A protective cover for preventing damage by vehicle tyres, comprising a strip of material adapted to be wrapped about the running surface of a tyre, and to cover at least part of the tyre side walls, the ends of the strip being adapted to overlap, and being provided with complementary securing means capable of being secured in any relative position within a range defined by the lengthwise extent of said securing means on at least one said end.

2. A protective cover according to claim 1, wherein the lengthwise extent of said securing means on at least one said end is a significant proportion of the length of the cover.

3. A protective cover according to claim 2, wherein the lengthwise extent of said securing means on at least one said end is from 20 to 30% of the length of the cover.

4. A protective cover according to claim 1, wherein said complementary securing means are provided on one said end of the strip on a first surface thereof which is adapted to face outwardly of a tyre in position of use, and disposed as one or more lengthwise strips on said first surface.

5. A protective cover according to claim 4, wherein said lengthwise strips are disposed are adjacent to and parallel to each respective longer side of the strip, extending from said end.

6. A protective cover according to claim 4, wherein said complementary securing means further comprise, disposed on the other said end of the strip on a second opposite surface thereof, are or more strips of material complementary to be engageable with the strip or strips provided on said one end of the strip.

7. A protective cover according to claim 6, wherein said complementary strip or strips include or comprise a strip extending adjacent and parallel to said other end of the strip on said second opposite surface, so as to be engageable with the lengthwise strips on said other end on overlapping said ends after wrapping the cover about a tyre.

8. A protective cover according to claim 1 wherein said complementary securing means comprise hook-and-pile complementary fasteners of the VELCRO tyre.

9. A protective cover according to claim 1, wherein the longitudinal edges of the strip are each formed with a tunnel seam, each said seam having an elastic cord extending there through and being anchored at each end of the cover strip.
